(19) United States
(12) Patent Application Publication
(10) Pub. No.: US 2008/0222701 A1
(43) Pub. Date: Sep. 11, 2008

(54) Using secondary bearer to detect proximity of a device

(75) Inventors: Mika Saaranen, Pirkkala (FI); Holger Hussmann, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: NOKIA CORPORATION

(21) Appl. No.: 11/714,705

(22) Filed: Mar. 5, 2007

(51) Int. Cl. H04L 9/32

(52) U.S. Cl. 726/3; 340/686.6

(57) ABSTRACT

A new and unique method or apparatus for providing protected transport of digital content from a first device to a second device, featuring activating a proximity link between the first and second devices; performing proximity detection between the first device and the second device; delivering the digital content from the first device to second device over a communications link when it is determined that the proximity between devices is within a predetermined range. The proximity link may take the form of a wireless link that is limited in its range with adequate authentication mechanisms, and may be either is an additional link compared to, for example, a wireless broadband link, or may even form part of the wireless broadband link if its broadband is sufficient. In operation, an actual streaming transfer or other suitable data transfer would be provided from one device to the other device using the additional link, such as the wireless broadband link. In particular, the proximity link may ensure that the physical proximity of the other device is in a certain range.

### BACKGROUND OF THE INVENTION

1. Field of Invention

The present invention relates to a method and apparatus for providing protected transport of audio/visual content by performing proximity detection between two devices connected via a network.

Moreover, the present invention also relates to device-to-device authentication method, device-to-device authentication system for authenticating whether or not the devices can exchange protected audio/visual content acquired under a digital rights management allowing private use. The present invention also relates to Digital Rights Management and other systems which require information that devices are ensured to be within some distance.

2. Description of Related Art

Content owners, publishers and copyright owners of digital media, e.g. audio and/or visual, are concerned that after the content has been distributed to legitimate users/devices it is further redistributed infringing the actually intended rights. Digital rights management (DRM) refers to technologies that allow content owners to control access to and usage of the content and to restrict the use and redistribution of digital content. Redistribution within close proximity of the authorized device is often allowed, however, further redistribution typically needs to be prevented.

Internet Protocol (IP) network refers to the global interconnection of different types networks using the IP network protocol which is a part of the Transport Control Protocol (TCP)/IP protocol suite. IP network layer protocol delivers data in units of packets which contain both data and address information. Proximity detection in IP networks is a difficult issue as such as IP does not provide a direct indication whether the other host is in close vicinity and it does not have generic mechanisms to connect IP address to the proximity of another IP address. This problem exists for IEEE 802-type networks where bridging can extend networks to be very wide. In addition, link layer networks such as IEEE 802 networks allow building geographically large networks over one IP subnetwork. There are other IP technologies that allow relocating IP addresses faraway from home network such as mobile IP. So, this problem is not specific only to IEEE 802 networks, of course, this is currently one of the most used link layer technologies.

In DRM systems, content providers (owners of the content like Hollywood studios) do restrict distribution of DRM protected content to be shown in devices close to a serving device like a set-top-box. In one specific instance, Digital Transmission Content Protection (DTCP) has defined a very strict time limit under which a rendering device must answer to the request of a serving device. DTCP specifies that content from the serving device to the rendering device is transferred only when they are in close proximity. DCTP estimates the proximity to be the round trip time (RTT) for IP packets between the devices. RTT time is typically set to a low value to denote closeness. However, in operation even though the devices could be physically close, the communications between the devices may contain a long network path. Additionally, the two devices may be connected via a communications link having a limited bandwidth with unreliable physical link. The communication path between the devices may be further asymmetrical, wherein a large RTT time could be due to the return path link capacity or the congestion level. Therefore, RTT may not be the optimal detector for proximity.

In some particular applications in DRM systems, it is necessary to detect whether another device is close-by or located anywhere. In a link level copy protection scheme such as DTCP, the standard allows transmitting content from the serving device to the rendering device only if is close by like in same apartment or even in the same room. DTCP makes this determination e.g. based on the RTT time that is defined very strictly to prevent streaming the content too far. However, in practice, the measurement of RTT time is set to so small a value that distribution is limited geographically to very small area. But one problem is that the currently defined time value is too small to allow streaming of DRM protected content from/to a phone to/from other device when the phone is communicating over Wireless bearer (plus in some cases into Local Area Network (LAN)).

In view of the aforementioned, there is a need for a new way to perform proximity detection between two devices, especially in wireless local area network (WLAN) or other suitable networks, for the purpose of providing protected transport of audio/visual content in a WLAN or other suitable network.

### SUMMARY OF THE INVENTION

The present invention provides a new and unique method and apparatus for providing protected transport of digital content from a first device to a second device, featuring activating a proximity link between the first and second devices; performing proximity detection between the first device and the second device; delivering the digital content from the first device to second device over a communications link when it is determined that the proximity between devices is within a predetermined range. The present invention provides a device-to-device authentication method, device-to-device authentication system for authenticating whether or not the devices can exchange protected audio/visual content acquired under a digital rights management allowing private use. The two devices may include one or more stations (STA), one or more access points (AP), one or more other suitable devices for operating in the WLAN, or some combination thereof.

The proximity link may take the form of a wireless link that is limited in its range with adequate authentication mechanisms, and may be either is an additional link compared to, for example, a wireless broadband link, or may even form part of the wireless broadband link if its broadband is sufficient. The communications link used to deliver digital content may be different from the proximity link. In operation, an actual streaming transfer or other suitable data transfer would be provided from one device to the other device using the additional link, such as the wireless broadband link. In one embodiment, the proximity link may ensure that the physical proximity of the other device is in a certain range, including that a WLAN device is closer than 100 meters from an access point in the WLAN, or that a BT device is closer than 10-30 meters away.

The present invention may also include the proximity detection taking the form of clicking the two devices in a short time period using radio frequency identification (RFID) technology in order to trigger the authorization to redistribute content for some determined period of time. Moreover, if RFID is used, then tapping and being able to exchange certain credentials can also create knowledge of the physical proximity of the other device.

In one particular embodiment, when a digital rights management (DRM) protected connection is established, both ends activate the proximity link and establish a connection with a bearer specific authentication. The information exchange may also include one or more certificates to increase the level of trust of proximity and identification in a digital rights management (DRM) application.

The present invention may include a wireless device featuring a module configured to activate a proximity link with another device and perform proximity detection between the devices; and a transmitter module configured to deliver the digital content from the first device to second device over a communications link when it is determined that the proximity between devices is within a predetermined range.

The present invention may also include the WLAN or other suitable network, wherein the proximity link is activated between the two devices in order to verify the physical proximity of one device to another device; as well as a node, point, terminal or device in the WLAN or other suitable network, such as a WLAN terminal, a station (STA), an access point (AP), etc.

Moreover, the scope of the invention may also include a WLAN chipset for such a node, point, terminal or device in such a WLAN or other suitable network, as well as a computer program product with a program code, which program code is stored on a machine readable carrier, for carrying out the steps of the method according to the present invention. The method may also feature implementing the step of the method via a computer program running in a processor, controller or other suitable module in such a WLAN terminal.

In effect, the present invention provides a new and unique method and apparatus for performing proximity detection between two devices comprising communications links with a limited physical range. The method and apparatus would be used to verify the proximity of devices for the purpose of protected transport of audio/visual content. The actual transfer of audio/visual content may happen over another communications link, e.g. 802.11 WLAN, than the link used for the proximity detection. The present invention provides a physical link, which is limited in its range (proximity communication) with adequate authentication mechanisms, that may be used to verify the proximity of one device to another device. This link may be solely used to verify the physical proximity between the two devices. The actual streaming transfer may be transferred over another wireless broadband link typically in our new products 802.11 wireless LAN (a, b, . . . , g, etc.). The present invention provides a solution that allows alternative mechanisms namely other kind of communication links to be used as proximity detectors.

### BRIEF DESCRIPTION OF THE DRAWINGS

The drawing includes the following Figures, which are not necessarily drawn to scale:

FIG. 1 shows an IEEE 802.11 WLAN system according to some embodiments of the present invention.

FIG. 2 shows a flowchart of the steps according to some embodiments of the present invention.

FIG. 3 shows one embodiment of a station (STA) that may operate in the WLAN in FIG. 1, the (UMTS) packet network architecture in FIGS. 5a, 5b, or some combination thereof, according to some embodiments of the present invention.

FIG. 4 shows one embodiment of an access point (AP) that may operate in the WLAN in FIG. 1, the (UMTS) packet network architecture in FIGS. 5a, 5b, or some combination thereof, according to some embodiments of the present invention.

FIGS. 5a and 5b show diagrams of the Universal Mobile Telecommunications System (UMTS) packet network architecture according to some embodiments of the present invention.

### DETAILED DESCRIPTION OF THE INVENTION

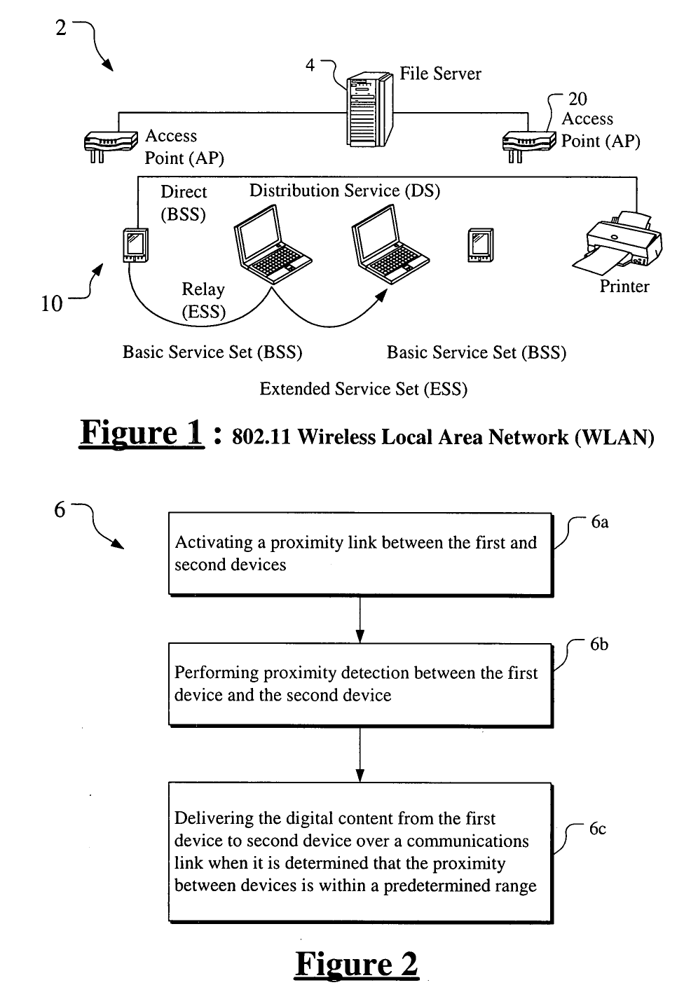

FIG. 1 shows, by way of example, of an IEEE 802.11 WLAN system, generally indicated as 2, which provides for communications between communications equipment such as mobile and secondary devices 10 including personal digital assistants (PDAs), laptops and printers, etc. The WLAN system 2 may be connected to a wired LAN system that allows wireless devices to access information and files on a file server 4 or other suitable device or connecting to the Internet.

The devices can communicate directly with each other in the absence of a base station in a so-called “ad-hoc” network, or they can communicate through a base station, called an access point (AP) in IEEE 802.11 terminology, with distributed services through the AP using local distributed services (DS) or wide area extended services, as shown. In the WLAN system 2, end user access devices are known as stations (STAs) 10, which are transceivers (transmitters/receivers) that convert radio signals into digital signals that can be routed to and from communications device and connect the communications equipment to access points (APs) 20 that receive and distribute data packets to other devices and/or networks. The STAs may take various forms ranging from wireless network interface card (NIC) adapters coupled to devices to integrated radio modules that are part of the devices, as well as an external adapter (USB), a PCMCIA card or a USB Dongle (self contained), which are all known in the art.

FIG. 2 shows a flowchart generally indicated as 6 of the steps 6a, 6b, 6c according to some embodiments of the present invention.

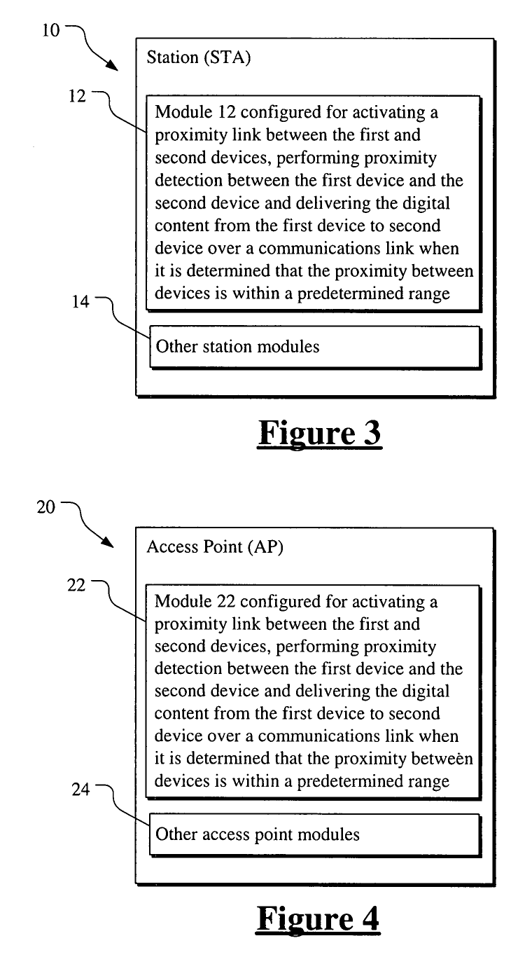

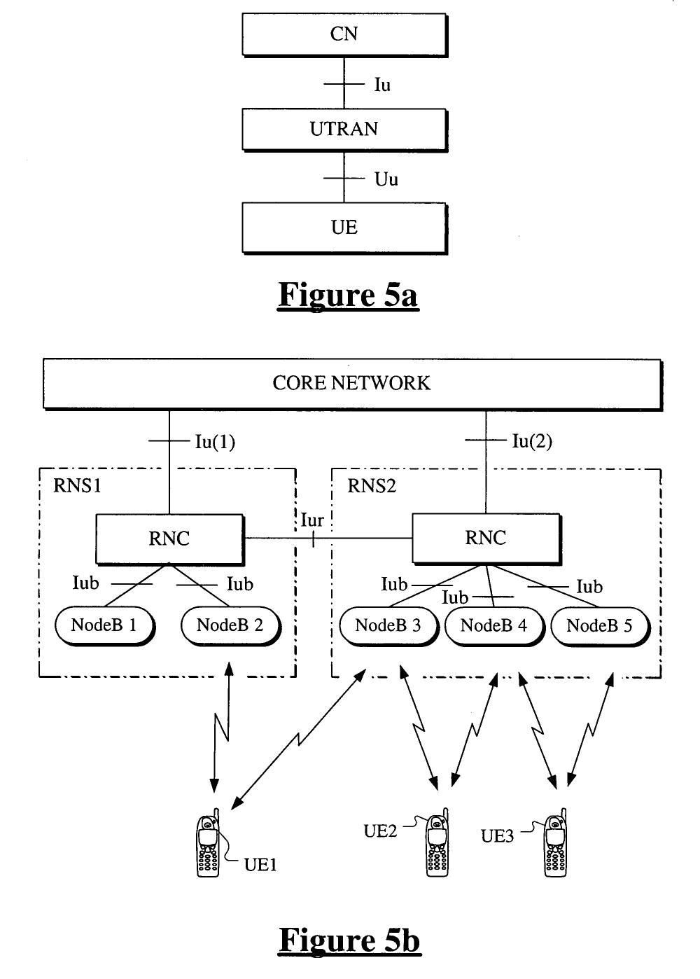

FIG. 3 shows one embodiment of a node, point, terminal or device according to one embodiment of the present invention in the form of a station (STA) generally indicated 10 that may operate in a wireless local area network (WLAN) or other suitable network such as that shown in FIG. 1, as well as 5a and 5b. In accordance with the present invention, the STA 10 has one or more proximity detection module 12 configured for activating a proximity link between the first and second devices, performing proximity detection between the first device and the second device and delivering the digital content from the first device to second device over a communications link when it is determined that the proximity between devices is within a predetermined range. In operation, the proximity link may be activated between the two devices, which may include two of the STAs 10, or the STA 10 and another device such as an Access Point (AP) shown in FIG. 1 or 4, and would exchange one or more signals to establish and main the proximity link consistent with that shown and described herein to implement the present invention. The STA 10 may also include other station modules 14 that do not form part of the underlying invention, including other modules enabling the STA to operate in the WLAN or other suitable network such as that shown in FIGS. 1, 5a and 5b, as well as modules to enable an interface between a user and the device.

FIG. 4 shows another embodiment of a node, point, terminal or device according to the present invention in the form of an access point (AP) generally indicated 20 that may also operate in the WLAN or other suitable network such as that shown in FIG. 1, as well as FIGS. 5a and 5b. In accordance with the present invention, the AP 20 also has a corresponding proximity detection module 22 configured for activating a proximity link between the first and second devices, performing proximity detection between the first device and the second device and delivering the digital content from the first device to second device over a communications link when it is determined that the proximity between devices is within a predetermined range. The AP 20 may include other access point modules 14 that do not form part of the underlying invention, including modules enabling the AP to operate in the WLAN or other suitable network such as that shown in FIG. 1, 5a and 5b, as well as modules to enable an interface between a user and the device.

Although the present invention is described in the form of the functionality being performed in a stand alone module, such as modules 12 or 22, for the purpose of describing the same herein, the scope of the invention is invention is intended to include the functionality of the modules 12 or 22 being implemented in whole or in part by one or more of these other modules 14 or 24. In other words, the scope of the invention is not intended to be limited to where the functionality of the modules 12 or 22 of the present invention is implemented in the STA 10 or AP 20.

In one embodiment of proximity detection according to the present invention, it is not necessary to be able to detect exact distances, but to determine that the other device is in certain range, e.g. in IEEE 802.11b device is closer that 100 m from the access point or BT power class 2 device is closer than 10-30 meters away.

Instead, it is basically required that a trust relationship exists between the proximity link and, e.g., a DRM application using the link. This applies on both ends of this proximity detection and it is part of the overall device planning and will necessarily be part of, e.g., the DRM specification developed now and in the future. In practice, this kind of trust relationship is requested already in DTCP license terms with liability consequences if broken.

Adding a proximity detection and a classification of devices within proximity in a trusted way can be an important enabler for home networks:

One embodiment of the invention may be implemented as follows:

1. Wireless broadband link may be established between a rendering device such as the STA 10 and a serving device such as the AP 10, which may take the form of a full path between these two devices and may include several kinds of links including also wired links, for instance, links in accordance with IEEE 802.11 and 802.3 specifications.

2. Both ends (the STA 10 and the AP 20) may also deploy an application using a proximity detection based on additional link compared to the wireless broadband link. In some cases, the proximity link might be same as the wireless broadband link, if its bandwidth is broad enough.

3. When, e.g., a DRM protected connection is being established, both ends (the STA 10 and the AP 20) activate the proximity link and establish a connection with, e.g., a bearer specific authentication. This authentication is used when building a trust that the device is close by. If RFID is used, then tapping and being able to exchange certain credentials can create implicit knowledge of proximity. There may also be an additional step, where, e.g., the DRM application ends are exchanging, e.g., certificates to increase the level of trust of proximity and identification.

4. While the connection of the proximity link between the STA 10 and AP 20 is on-going, either end of the proximity link may periodically check if the other end is still reachable over the proximity link. This may include various message exchanges or re-authentication or just detection link's existence. In case of RFID type detection, the rendering device may show after a pre-determined period that the server device needs to be tapped.

5. The proximity detection link technology may comprise the form of, e.g. Bluetooth (BT), UWB, Zigbee, infrared (IR), etc., and is not intended to be limited to any particular link technology either now known or later developed in the future.

6. In operation, the proximity link can be turned off or put on energy save mode between times when periodic checks are made. A typical period for a wireless proximity link could vary from seconds to several minutes or even tens of minutes, but in the RFID case this would possibly be number of half hours.

The present invention may also include the proximity detection being extended with a proxy function, i.e. if a device in the network which is in proximity as proven, i.e. by the RTT measurement has Bluetooth functionality and the verification of the Bluetooth proximity is delegated to these devices, the new Bluetooth device can be added to the proximity domain. Bluetooth is seen here as an example and it could be other short-range technology, like i.e. IR, or RFID used to verify the proximity. In effect, the proxy provides RTT measurements in e.g. the WLAN network or LAN network where the RTT requirement can be fulfilled and it also takes care of verifying that the device in e.g. the Bluetooth network is close enough.

In operation, the present invention allows proximity detection with additional proximity communication and therefore e.g. DTCP (link local copy protection technology chosen by DLNA) can be used also in many terminals, even if it cannot reach required RTT boundaries. Also some terminals typically already include a BT link and adding a BT support on CE devices or media adapters may not be too difficult or expensive. Also, it is possible to deploy, e.g. BT APs on this or USB BT stick. It also provides a reasonably secure proximity detection scheme.

By way of example, and consistent with that described herein, the modules 12 and 22 may be configured for implementing the present invention, including performing proximity detection between two devices in a wireless local area network (WLAN) by activating a proximity link between the two devices in order to verify the physical proximity of one device to another device, using hardware, software, firmware, or a combination thereof, although the scope of the invention is not intended to be limited to any particular embodiment thereof. In a typical software implementation, the module 18 would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology now known or later developed in the future. Moreover, the scope of the invention is intended to include the module 12 or 22 being a stand alone module, as shown, or in the combination with other circuitry for implementing another module. Moreover, the real-time part may be implemented in hardware, while non real-time part may be done in software.

The other modules 14 or 24 may also include other modules, circuits, devices that do not form part of the underlying invention per se. The functionality of the other modules, circuits, device that do not form part of the underlying invention are known in the art and are not described in detail herein.

The present invention may also take the form of the WLAN chipset for such a node, point, terminal or device like the STA 10 in a wireless local area network (WLAN) or other suitable network, that may include a number of integrated circuits designed to perform one or more related functions. For example, one chipset may provide the basic functions of a modem while another provides the CPU functions for a computer. Newer chipsets generally include functions provided by two or more older chipsets. In some cases, older chipsets that required two or more physical chips can be replaced with a chipset on one chip. The term “chipset” is also intended to include the core functionality of a motherboard in such a node, point, terminal or device.

FIGS. 5a and 5b show diagrams of the Universal Mobile Telecommunications System (UMTS) packet network architecture, which is also known in the art. In FIG. 5a, the UMTS packet network architecture includes the major architectural elements of user equipment (UE), UMTS Terrestrial Radio Access Network (UTRAN), and core network (CN). The UE is interfaced to the UTRAN over a radio (Uu) interface, while the UTRAN interfaces to the core network (CN) over a (wired) Iu interface. FIG. 2b shows some further details of the architecture, particularly the UTRAN, which includes multiple Radio Network Subsystems (RNSs), each of which contains at least one Radio Network Controller (RNC). In operation, each RNC may be connected to multiple Node Bs which are the UMTS counterparts to GSM base stations. Each Node B may be in radio contact with multiple UEs via the radio interface (Uu) shown in FIG. 5a. A given UE may be in radio contact with multiple Node Bs even if one or more of the Node Bs are connected to different RNCs. For instance, a UE1 in FIG. 5b may be in radio contact with Node B2 of RNS1 and Node B3 of RNS2 where Node B2 and Node B3 are neighboring Node Bs. The RNCs of different RNSs may be connected by an Iur interface which allows mobile UEs to stay in contact with both RNCs while traversing from a cell belonging to a Node B of one RNC to a cell belonging to a Node B of another RNC.

The convergence of the IEEE 802.11 WLAN system in FIG. 1 and the (UMTS) packet network architecture in FIGS. 5a and 5b has resulted in STAs taking the form of UEs, such as mobile phones or mobile terminals. The interworking of the WLAN (IEEE 802.11) shown in FIG. 1 with such other technologies (e.g. 3GPP, 3GPP2 or 802.16) such as that shown in FIGS. 5a and 5b is being defined at present in protocol specifications for 3GPP and 3GPP2. In recent years, wireless LAN technology has become very popular because of its advantage in price and bandwidth. Nowadays, wireless LAN is mainly used for Internet access, but real-time application like Voice over IP (VoIP) and video on demand (Vod) are identified as the future applications for wireless LAN. The scope of the invention is intended to include implementation of the same in such a UMTS packet network architecture as that shown FIGS. 5a and 5b.

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

What is claimed is:

1. A method for providing protected transport of digital content from a first device to a second device comprising:
activating a proximity link between the first and second devices;
performing proximity detection between the first device and the second device;
delivering the digital content from the first device to second device over a communications link when it is determined that the proximity between devices is within a predetermined range.

2. A method according to claim 1, wherein the proximity link is a wireless link that is limited in its range with adequate authentication mechanisms.

3. A method according to claim 1, wherein the communications link used to deliver digital content is different from the proximity link.

4. A method according to claim 1, wherein the proximity detection includes clicking the two devices in a short time period using radio frequency identification (RFID) technology in order to trigger the authorization to redistribute content for some determined period of time.

5. A method according to claim 1, wherein when a digital rights management protected connection is established, both ends activate the proximity link and establish a connection with a bearer specific authentication.

6. A method according to claim 1, wherein the information exchange includes one or more certificates to increase the level of trust of proximity and identification in a digital rights management (DRM) application.

7. A method according to claim 1, wherein while a connection is ongoing, one end of the proximity link is periodically checking if the other end is still reachable over the proximity link.

8. A method according to claim 7, wherein the periodic checking includes various message exchanges, or reauthorization, or detecting the existence of the proximity link.

9. A method according to claim 1, wherein the method further comprises extending proximity detection with a proxy function.

10. A method according to claim 1, wherein the physical proximity is verified within a predetermined range.

11. A wireless device comprising:
a module configured to:
activate a proximity link with another device, and
perform proximity detection between the devices; and
a transmitter module configured to deliver the digital content from the first device to second device over a communications link when it is determined that the proximity between devices is within a predetermined range.

12. A wireless device according to claim 11, wherein the proximity link is a wireless link that is limited in its range with adequate authentication mechanisms.

13. A wireless device according to claim 11, wherein communications link used to deliver digital content is different from the proximity link.

14. A wireless device according to claim 11, wherein the proximity detection includes clicking the two devices in a short time period using radio frequency identification (RFID) technology in order to trigger the authorization to redistribute content for some determined period of time.

15. A wireless device according to claim 11, wherein when a digital rights management protected connection is established, both ends activate the proximity link and establish a connection with a bearer specific authentication.

16. A wireless device according to claim 11, wherein the information exchange includes one or more certificates to increase the level of trust of proximity and identification in a digital rights management (DRM) application.

17. A wireless device according to claim 11, wherein while a connection is ongoing, one end of the proximity link is periodically checking if the other end is still reachable over the proximity link.

18. A wireless device according to claim 17, wherein the periodic checking includes various message exchanges, or reauthorization, or detecting the existence of the proximity link.

19. A wireless device according to claim 11, wherein proximity detection is extended with a proxy function.

20. A wireless device according to claim 11, wherein the physical proximity is verified within a predetermined range.
